(19) United States
(12) Patent Application Publication
(10) Pub. No.: US 2025/0342688 A1
(43) Pub. Date: Nov. 6, 2025

(54) ABNORMALITY DIAGNOSIS DEVICE

(71) Applicant: HITACHI ASTEMO, LTD., Hitachinaka-shi, Ibaraki (JP)

(72) Inventors: Takeru NINOMIYA, Chiyoda-ku, Tokyo (JP); Kota IRIE, Hitachinaka-shi, Ibaraki (JP)

(73) Assignee: HITACHI ASTEMO, LTD., Hitachinaka-shi, Ibaraki (JP)

(21) Appl. No.: 18/855,451

(22) PCT Filed: Mar. 20, 2023
(86) PCT No.: PCT/JP2023/010814

§ 371 Date: Oct. 9, 2024

(30) Foreign Application Priority Data
May 9, 2022 (JP) 2022-076822

(51) Int. Cl. G06V 10/98; G06T 7/00; G06V 20/58

(52) U.S. Cl. CPC G06V 10/98; G06T 7/97; G06V 20/58; G06V 2201/07

(57) ABSTRACT

Provided is an abnormality diagnosis device capable of determining an abnormal region generated in a sensor in a short time. The abnormality diagnosis device includes: a target reliability determination unit 400 which determines reliability of a target based on a detection result in a common imaging region; and an individual abnormal image region determination unit 500 which determines an abnormal image region in a monocular region using a tracking result of the target in the monocular region, wherein the individual abnormal image region determination unit 500 changes an abnormality score of an abnormality score map assigned to an abnormal image region according to the reliability of the target.

### TECHNICAL FIELD

The present invention relates to an abnormality diagnosis device that appropriately diagnoses an abnormal region generated in a sensor installed in a moving body.

### BACKGROUND ART

In recent years, in automatic driving, driving support technology, and the like, it is required to appropriately recognize a surrounding environment based on sensor information provided in a moving body. In a case where an abnormal region such as dirt or a scratch of a lens appears in a sensor mounted on a moving body, there is a possibility that a surrounding environment is erroneously recognized, and thus, it is necessary to detect the abnormal region early.

Conventionally, there is a method of setting a region where a target object cannot be tracked as an abnormal region, and PTL 1 describes that “detect whether or not an object tracking process is in an abnormal state”. For example, in a case where a pedestrian is tracked in FIG. 13(a), the region in which the pedestrian can be tracked is regarded as normal, and the region in which the pedestrian cannot be tracked is regarded as abnormal, and the abnormality score map illustrated in FIG. 13(b) is updated.

### CITATION LIST

### Patent Literature

PTL 1: JP 2007-272436 A

### SUMMARY OF INVENTION

### Technical Problem

However, in the conventional technique disclosed in PTL 1, it is not possible to appropriately estimate an abnormal region in a case where dirt, a scratch on a lens, or the like is erroneously detected as a target object. FIGS. 13(c) and 13(d) show scenes to be solved. In a case where dirt is erroneously detected as a target as illustrated in FIG. 13(c), the value of the abnormality score map of the detected region is updated to be normal as illustrated in FIG. 13(d). As such an erroneous detection countermeasure, it is conceivable to determine an abnormal region based on detection results at a plurality of times; however, it takes time to confirm the abnormal region.

The present invention has been made in view of the above circumstances, and an object thereof is to provide an abnormality diagnosis device capable of determining an abnormal region generated in a sensor in a short time.

### Solution to Problem

In order to solve the above problem, one aspect of an abnormality diagnosis device according to the present invention includes: a sensor unit in which a plurality of cameras are arranged so as to overlap in a visual field; a target detection unit which detects a target based on sensor information of the sensor unit; a target reliability determination unit which determines reliability of the target based on a detection result in a common imaging region in which the plurality of cameras share a visual field; and an individual abnormal image region determination unit which determines an abnormal image region in a monocular region using a tracking result of the target in the monocular region formed only by a visual field of a single camera in the plurality of cameras, wherein the individual abnormal image region determination unit changes an abnormality score of an abnormality score map assigned to the abnormal image region according to the reliability of the target.

Another aspect of an abnormality diagnosis device according to the present invention includes: a sensor unit in which a plurality of sensors are arranged so as to overlap in an observation region; a target detection unit which detects a target based on sensor information of the sensor unit; a target reliability determination unit which determines reliability of the target based on a detection result in a common sensing region in which the plurality of sensors share an observation region; and an individual abnormal region determination unit which determines an abnormal region in a single sensing region using a tracking result of the target in the single sensing region formed only by an observation region of a single sensor in the plurality of sensors, wherein the individual abnormal region determination unit changes an abnormality score of an abnormality score map assigned to the abnormal region according to the reliability of the target.

### Advantageous Effects of Invention

According to the present invention, the abnormal region generated in the sensor can be determined in a short time.

Problems, configurations, and effects other than those described will be clarified by the following description of embodiments.

### BRIEF DESCRIPTION OF DRAWINGS

FIG. 1 is a block diagram illustrating an overall configuration example of an abnormality diagnosis device according to a first embodiment of the present invention.

FIG. 2 illustrates a configuration example of a sensor unit 100 according to the first embodiment of the present invention, where FIG. 2(a) is an example thereof, and FIG. 2(b) is an overhead view of another example.

FIG. 3 illustrates an operation example of a target detection unit 200 according to the first embodiment of the present invention., where FIG. 3(a) is an explanatory diagram of a template (another vehicle), FIG. 3(b) is an explanatory diagram of a template (pedestrian), and FIG. 3(c) is an explanatory diagram of a traveling scene.

FIG. 4 illustrates an example of a common normal region of a common normal region calculation unit 300 according to the first embodiment of the present invention, where FIG. 4(a) is an explanatory diagram of an acquired image of a left front camera 110 and FIG. 4(b) is an explanatory diagram of an acquired image of a right front camera 120 (both images are normal).

FIG. 5 illustrates an example of a common normal region of a common normal region calculation unit 300 according to the first embodiment of the present invention, where FIG. 5(a) is an explanatory diagram of an acquired image of a left front camera 110, and FIG. 5(b) is an explanatory diagram of an acquired image of a right front camera 120 (right image is abnormal).

FIG. 6 is a processing flowchart of the common normal region calculation unit 300 according to the first embodiment of the present invention.

FIG. 7 is a processing flowchart of a target reliability determination unit 400 according to the first embodiment of the present invention.

FIG. 8 is an example of an operation of an individual abnormal image region determination unit 500 according to the first embodiment of the present invention, where FIG. 8(a) is an explanatory diagram of target detection information, and FIG. 8(b) is an explanatory diagram of an abnormality score map for FIG. 8(a).

FIG. 9 is a processing flowchart of the individual abnormal image region determination unit 500 according to the first embodiment of the present invention.

FIG. 10 is a block diagram illustrating an overall configuration example of an abnormality diagnosis device according to a second embodiment of the present invention.

FIG. 11 is an overhead view illustrating a configuration example of a sensor unit 1100 according to the second embodiment of the present invention.

FIG. 12 is a processing flowchart of a target reliability determination unit 1400 according to the second embodiment of the present invention.

FIG. 13 is a diagram of explaining a problem to be solved, where FIG. 13(a) is an explanatory diagram of target detection information (pedestrian, including dirt), FIG. 13(b) is an explanatory diagram of an abnormality score map (pedestrian, including dirt) for FIG. 13(a), FIG. 13(c) is an explanatory diagram of target detection information (including dirt), and FIG. 13(d) is an explanatory diagram of an abnormality score map (including dirt) for FIG. 13(c).

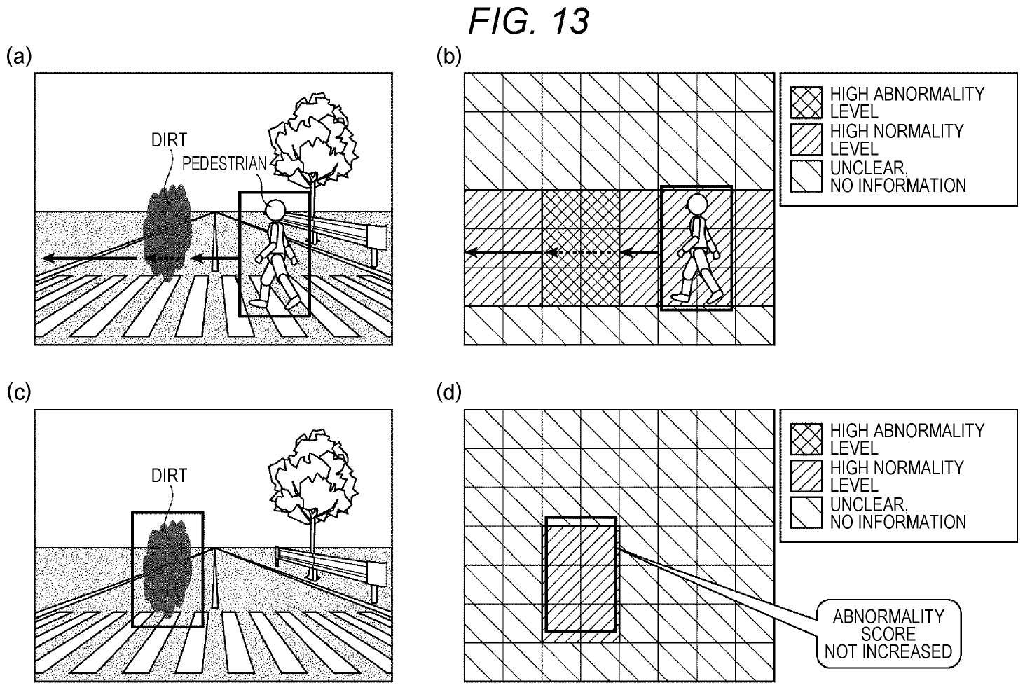

### DESCRIPTION OF EMBODIMENTS

Hereinafter, embodiments of the present invention will be described with reference to the drawings. In the drawings, parts having the same functions or configurations are denoted by the same reference numerals, and repeated description may be omitted.

### First Embodiment

The first embodiment is an embodiment in which a plurality of sensors that are installed in a moving body and observe a surrounding environment include cameras, and normality or abnormality determination of a common imaging region of the plurality of sensors (cameras) is performed by matching of identical pixels.

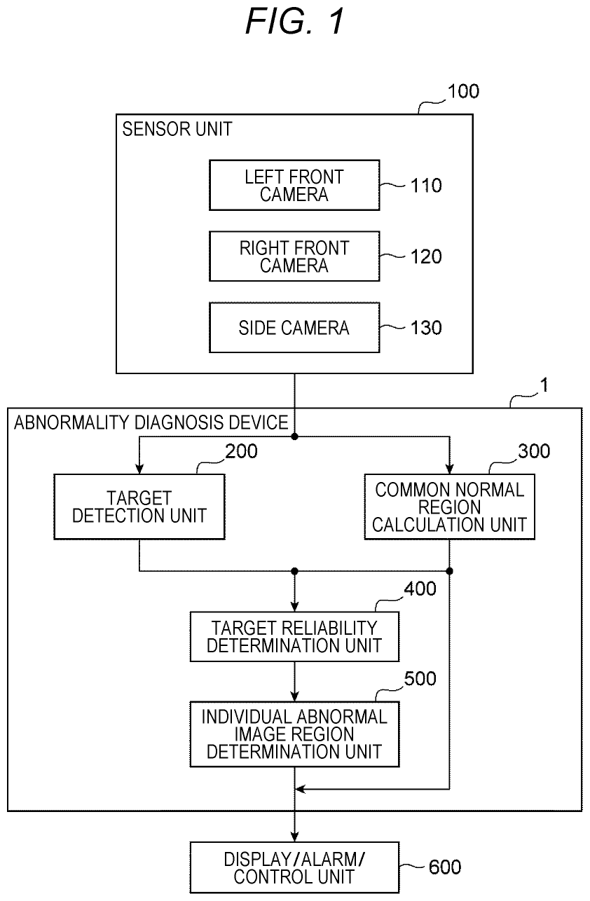

FIG. 1 illustrates an overall configuration diagram of an abnormality diagnosis device according to the first embodiment of the present invention.

An abnormality diagnosis device 1 of the present embodiment is, for example, used as being mounted on a vehicle, and includes a sensor unit 100, a target detection unit 200, a common normal region calculation unit 300, a target reliability determination unit 400, an individual abnormal image region determination unit 500, and a display/alarm/control unit 600.

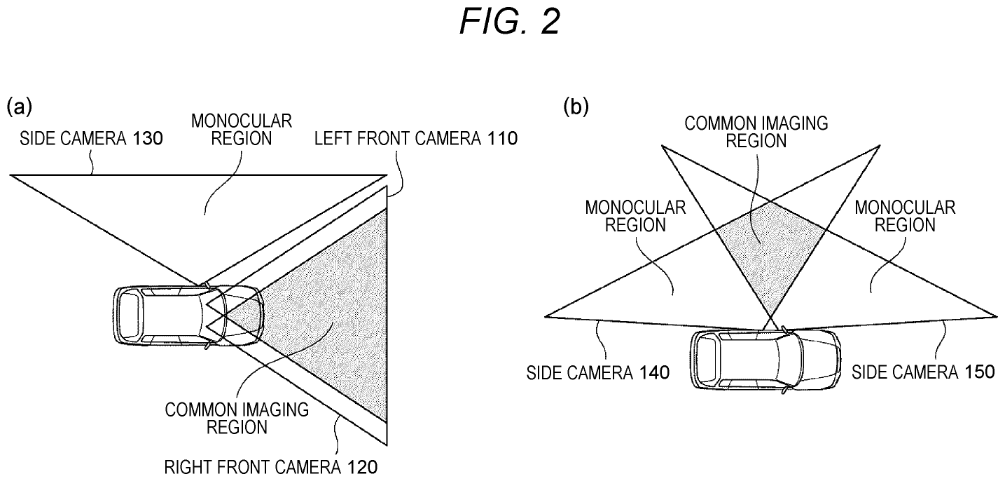

The sensor unit 100 includes a plurality of imaging devices (cameras). The plurality of cameras are arranged so as to overlap in visual fields. FIG. 1 illustrates an example in which the sensor unit 100 includes three cameras of a left front camera 110, a right front camera 120, and a side camera 130. As illustrated in FIG. 2(a), the three cameras are arranged such that there are a common imaging region that can be imaged by two cameras of the left front camera 110 and the right front camera 120 (two cameras of the left front camera 110 and the right front camera 120 share a view field) and a monocular region that can be imaged only by one (single) camera of the side camera 130 (formed only by a view field of one (single) camera of the side camera 130).

Hereinafter, the camera system illustrated in FIG. 2(a) is described as an example, but another configuration may be used as long as the camera system has both the common imaging region and the monocular region. For example, as illustrated in FIG. 2(b), a camera system may be used in which two cameras of a side camera 140 and a side camera 150 are installed so as to overlap in visual fields.

The sensor unit 100 outputs image information obtained by imaging the surrounding environment as sensor information to the target detection unit 200 and the common normal region calculation unit 300.

The target detection unit 200 detects a target to be used for estimation of an abnormal region from image information as sensor information acquired by the sensor unit 100. The target may be another vehicle, a two-wheeled vehicle, a pedestrian, a sign, an object such as a signboard, or the like.

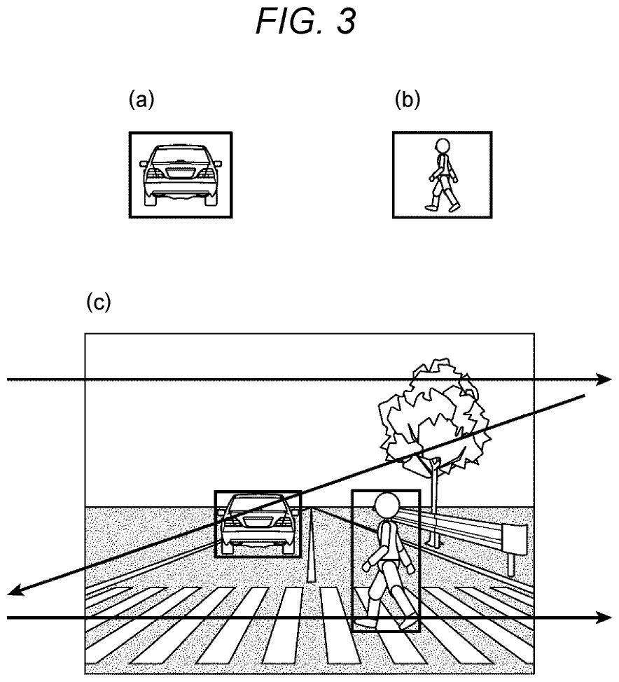

As a detection method, there is a method of using a template image of a vehicle or a pedestrian as illustrated in FIGS. 3(a) and 3(b). As illustrated in FIG. 3(c), the template image is scanned with respect to the image acquired by the sensor unit 100 during traveling, and a similar region is detected as a target. Furthermore, the method is not limited to such a template matching method, and the target may be detected by an arbitrary algorithm.

In a case where a target can be detected from the image acquired by the sensor unit 100, the target detection unit 200 outputs a position and a feature of the target in the image to the target reliability determination unit 400. The feature may include histograms of oriented gradients (HOG) feature obtained by forming a histogram of a luminance gradient direction of a detected target region, but the feature may be calculated by other arbitrary algorithms.

In addition, in a case where the moving direction in the image, the distance to the target, and the moving speed in the three-dimensional space can be calculated, the target detection unit 200 may also output the information to the target reliability determination unit 400. In addition, since there is a possibility of outputting an erroneous detection result in detection of a single time, the target detection unit 200 may output detection results in time series obtained by analyzing the detection results of the target in a plurality of frames to the target reliability determination unit 400.

Furthermore, a characteristic region in the image such as an edge or a corner may be included in the target.

In the common imaging region in which the visual fields of the left front camera 110 and the right front camera 120 overlap (the visual fields are shared), the common normal region calculation unit 300 confirms the presence or absence of an attachable matter (dirt, raindrops, white turbidity, icing, and the like) to a lens or a lens abnormality (cracks, scratches, distortions, and the like), and determines whether the common imaging region is normal or abnormal. The common normal region calculation unit 300 outputs the determination result to the target reliability determination unit 400 or the display/alarm/control unit 600.

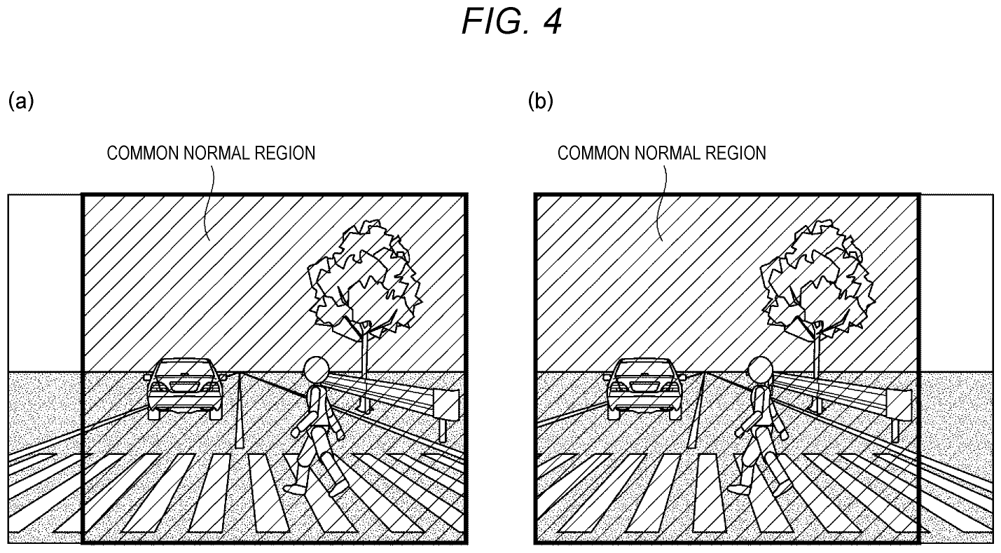

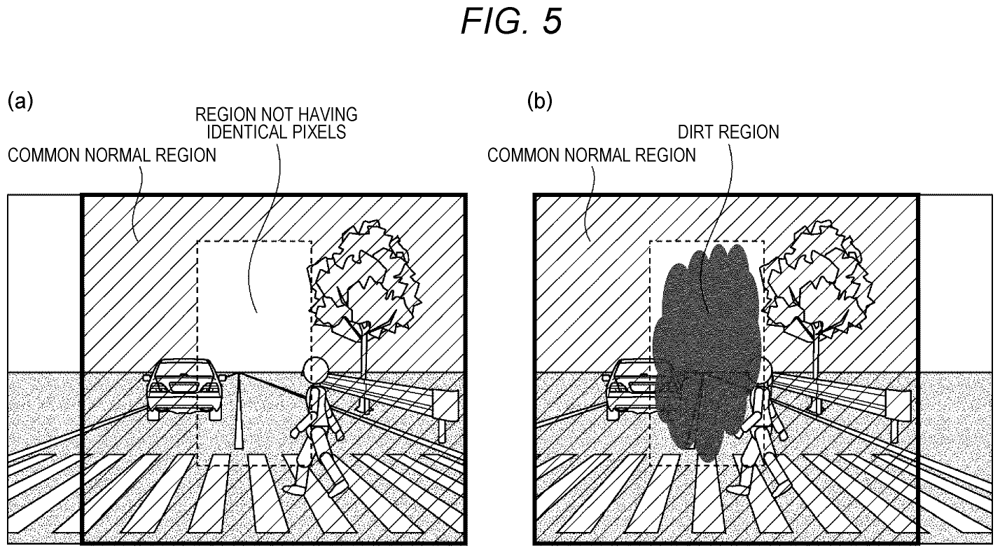

The common normal region calculation unit 300 determines whether the common imaging region is normal or abnormal by searching for the identical pixel relative to the images captured by the two cameras having the common imaging region. As illustrated in FIGS. 4(a) and 4(b), in a case where neither the left front camera 110 nor the right front camera 120 has abnormal state such as an attachable matter to a lens or a lens abnormality (in other words, in a case where both the image acquired by the left front camera 110 and the image acquired by the right front camera 120 are normal), the identical pixels are calculated in hatched regions in FIGS. 4(a) and 4(b). On the other hand, as illustrated in FIGS. 5(a) and 5(b), in a case where an abnormality has occurred in one image (here, the right image that is the acquired image of the right front camera 120), the identical pixels are calculated in hatched regions in FIGS. 5(a) and 5(b). The common normal region calculation unit 300 stores the regions in which the identical pixels are calculated as common normal regions. That is, the common normal region calculation unit 300 calculates, as the common normal region, the identical pixels matched between the cameras sharing the visual field (the left front camera 110 and the right front camera 120).

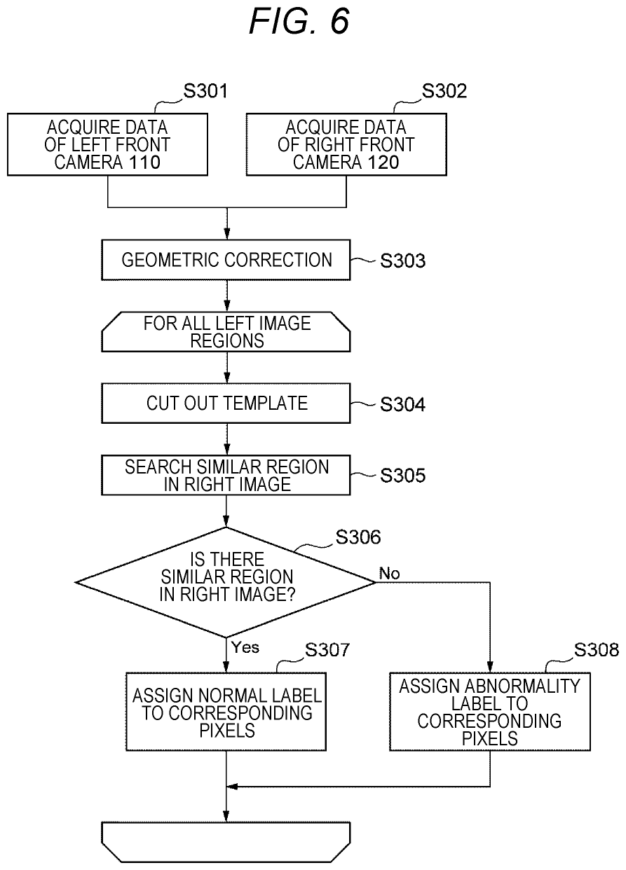

FIG. 6 illustrates a processing flow of the common normal region calculation unit 300. FIG. 6 illustrates an example in a camera configuration in which the left front camera 110 and the right front camera 120 have a common imaging region, but similar processing can be executed as long as the cameras have a common imaging region.

In steps S301 and S302, images captured by the left front camera 110 and the right front camera 120 having the common imaging region are acquired.

In the geometric correction in step S303, optical characteristics such as lens distortion are corrected with respect to the acquired image.

The identical pixels are searched for in the geometrically corrected image. In step S304, a local region of the image (left image) captured by the left front camera 110 is cut out as a template. Further, in step S305, a region similar to the cut-out template is searched from the image (right image) captured by right front camera 120. In a case where there is a similar region in the right image (matching succeeded) in step S306, a normal label is assigned to the corresponding pixels in step S307. In a case where there is no similar region in the right image (matching failed) in step S306, an abnormality label is assigned to the corresponding pixels in step S308. By performing this processing on the entire image, the common normal region is determined.

The search for the identical pixels is not limited to such a template matching method, and the identical pixels may be searched by an arbitrary algorithm.

The target reliability determination unit 400 receives the results of the target detection unit 200 and the common normal region calculation unit 300, and assigns reliability to each target detected by the target detection unit 200. The target reliability determination unit 400 outputs the result of assigning the reliability for each target to the individual abnormal image region determination unit 500.

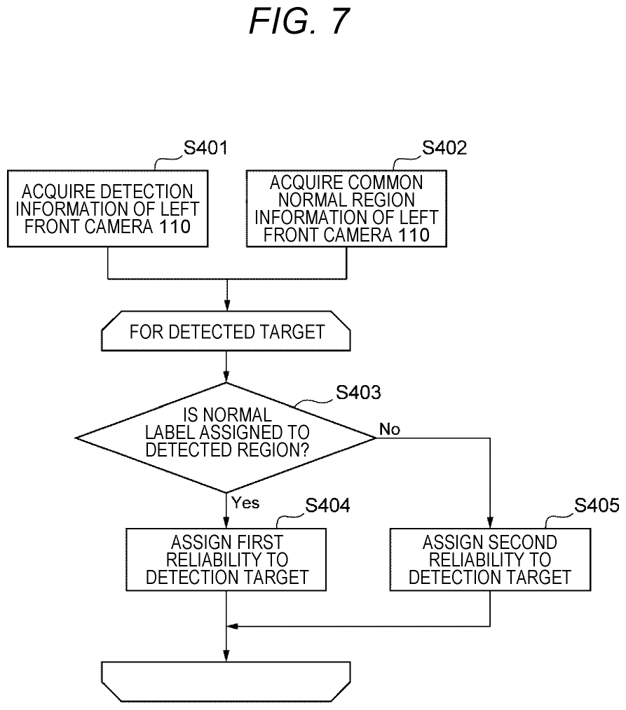

FIG. 7 illustrates a processing flow of the target reliability determination unit 400. FIG. 7 illustrates an example in the left front camera 110, but the present invention is not limited thereto, and similar processing can be executed as long as the camera has common normal region information.

First, in step S401, target information (detection information) of the left front camera 110 detected by target detection unit 200 is acquired.

Further, in step S402, common normal region information of the left front camera 110 calculated by the common normal region calculation unit 300 is acquired.

In a case where a detected position of a target detected by the target detection unit 200 is included in the common normal region (in other words, a normal label is assigned to a target region detected by the target detection unit 200) in step S403, first reliability is assigned to the target in step S404. In a case where a detected position of a target detected by the target detection unit 200 is not included in the common normal region (in other words, a normal label is not assigned to the target region detected by the target detection unit 200) in step S403, second reliability is assigned to the target in step S405. That is, the target reliability determination unit 400 assigns the first reliability to the target detected in the common normal region (step S404), and assigns the second reliability to the target detected outside the common normal region (step S405). In other words, the target reliability determination unit 400 assigns different reliability to the target detected in the common normal region and the target detected outside the common normal region.

Since it is desired to set the reliability of the target detected in the common normal region to be higher than the reliability of the target detected in the other region, a predetermined value is set in advance such that the first reliability becomes larger (higher) than the second reliability. In addition, in a case where the detection result in time series obtained by analyzing the detection results of the target in a plurality of frames can be acquired from the target detection unit 200, the first reliability and the second reliability may be calculated including the information of the past detection results.

The individual abnormal image region determination unit 500 determines an abnormal image region in the monocular region based on the reliability for each target calculated by the target reliability determination unit 400, and outputs the result to the display/warning/control unit 600.

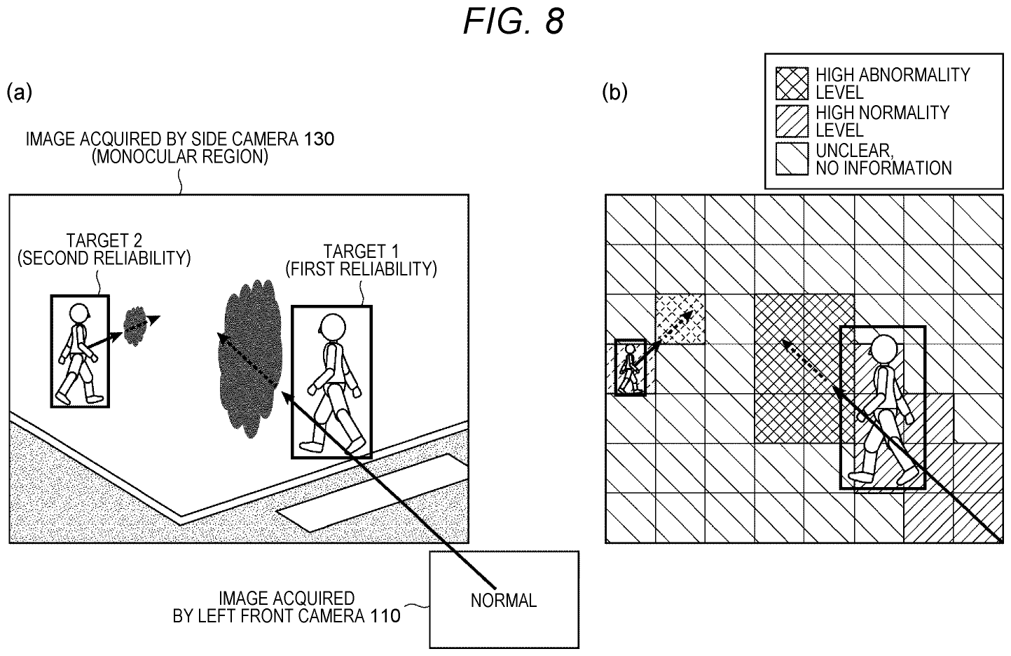

FIGS. 8(a) and 8(b) illustrate an outline of processing of the individual abnormal image region determination unit 500. Although the side camera 130 is described as an example in FIGS. 8(a) and 8(b), similar processing can be performed in other monocular regions. A target 1 in FIG. 8(a) indicates a pedestrian who has moved to the image (monocular region) acquired by the side camera 130 after being detected by (an image acquired by) the left front camera 110. It is assumed that the left front camera 110 is normal, and the first reliability is assigned to the target 1. A target 2 in FIG. 8(a) indicates a pedestrian detected for the first time by (an image acquired by) the side camera 130, and is detected outside the common normal region. Therefore, it is assumed that the second reliability is assigned to the target 2.

FIG. 8(b) illustrates the abnormality score map, and stores the abnormality score corresponding to the side camera 130. The abnormality score takes a value of 0 to 1, and can be defined as normal approaching 0 and abnormal as approaching 1, but the normal or abnormal state may be stored with any other numerical value. The abnormality score map is updated by the detection information of the target 1 and the target 2. In a case where the target is detected, the abnormality score map is updated so as to approach 0 (normal). In a case where the target cannot be detected, the abnormality score map is updated so as to approach 1(abnormal). The update amount of the abnormality score of the abnormality score map at that time is changed according to the reliability of the target, and processing is performed such that the abnormality score of the abnormality score map is updated to be larger as the reliability of the target is higher.

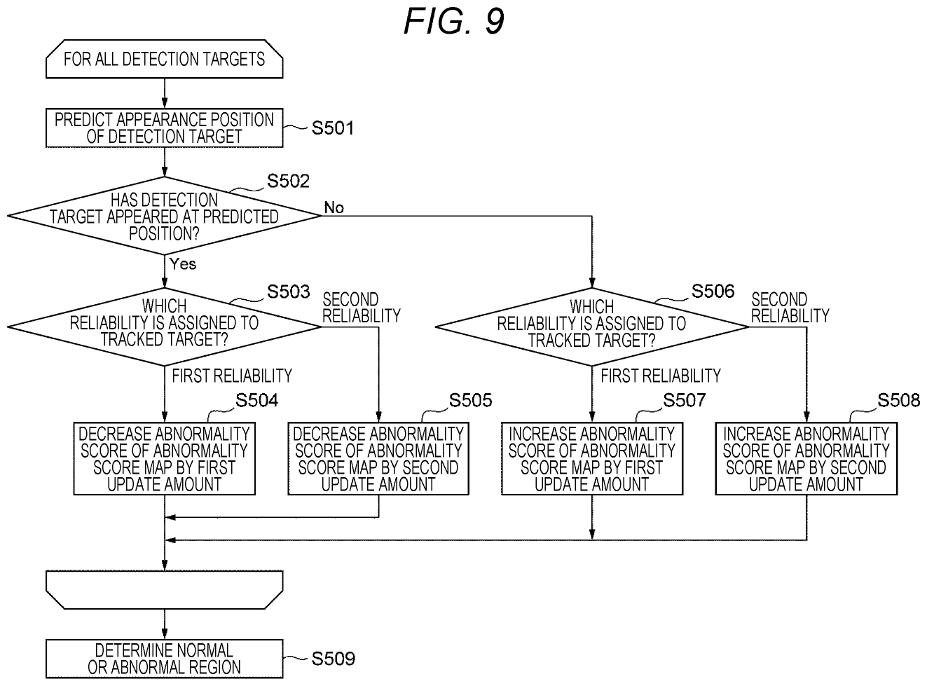

FIG. 9 illustrates a processing flow of the individual abnormal image region determination unit 500.

First, in step S501, the appearance position of the target detected by the target detection unit 200 is predicted. The surroundings of the position at the previous time may be used as the predicted appearance position. In a case where the movement direction of the target is calculated, the predicted appearance position may be determined based on the information. In a case where the movement amount of the own vehicle is known, the information may be used.

In S502, whether a target has appeared at the predicted position is determined based on the feature of the target. Further, in S503 and S506, the reliability assigned to the tracked target is confirmed. In a case where the target appears at the prediction position in S502, and the first reliability is assigned to the target in S503, the abnormality score of the abnormality score map is decreased by a first update amount in step S504. In a case where the second reliability is assigned to the target in S503, the abnormality score of the abnormality score map is decreased by a second update amount in step S505. In a case where the target does not appear at the position predicted in S502, and the first reliability is assigned to the target in S506, the abnormality score of the abnormality score map is increased by the first update amount in step S507. In a case where the second reliability is assigned to the target in S506, the abnormality score of the abnormality score map is increased by the second update amount in step S508. That is, in a case where the target is detected (tracked) in the monocular region, the individual abnormal image region determination unit 500 decreases (lowers) the abnormality score of the abnormality score map of the detection portion (by the first update amount or the second update amount) (steps S504 and S505). In addition, the individual abnormal image region determination unit 500 increases (heightens) the abnormality score of the abnormality score map of the lost portion (by the first update amount or the second update amount) in a case where the target is lost (cannot be tracked) in the monocular region (steps S507 and S508).

In a case where the targets overlap each other, the rear target cannot be imaged by the camera, and thus the target cannot be detected at the predicted position in some cases. In such cases, in order not to erroneously increase the value of the abnormality score map, processing of detecting overlapping of the targets based on the positional relationship between the targets and not using the target determined to be hidden behind the target for updating the abnormality score map may be included. In a case where the distance or the three-dimensional coordinates of the target are known, the overlap between the targets may be determined using the information.

Since it is desired to update the abnormality score of the abnormality score map to be larger for the target to which the first reliability is assigned than for the target to which the second reliability is assigned, a predetermined value is set in advance such that the first update amount is larger than the second update amount.

After updating the abnormality score of the abnormality score map using all the target information, the normal or abnormal region is determined in step S509. A predetermined threshold is set for the abnormality score of the updated abnormality score map, and a region in which the score falls below the predetermined threshold is determined as a normal region, and a region in which the score exceeds the predetermined threshold is determined as an abnormal region.

In addition, the abnormality score map may be also updated for a region determined as a normal region or an abnormal region, and it may be determined that an abnormality has occurred in the normal region in a case where the score exceeds the predetermined threshold (dirt adheres during traveling, or the like), or it may be determined that the abnormal region has been restored (dirt removed during traveling, dirt removed by cleaning operation, or the like) in a case where the score falls below the predetermined threshold.

The display/alarm/control unit 600 acquires information of a normal region or an abnormal region calculated by the common normal region calculation unit 300 or the individual abnormal image region determination unit 500, and performs display or provides an alarm to the driver, and/or performs control for eliminating an abnormal state.

In a case where the display/alarm/control unit 600 receives information that the imaging region of the camera is normal, the display/alarm/control unit 600 performs display indicating that the mounted camera is normal to the driver. In a case where the camera information is used in automatic driving, a driving support system, or the like, the display/alarm/control unit 600 may perform display indicating that the system is operating normally.

On the other hand, in a case where the display/alarm/control unit 600 receives information that an abnormal state has occurred in the imaging region of the camera, the display/alarm/control unit 600 performs display indicating that the mounted camera is abnormal to the driver. In a case where the camera information is used in automatic driving, a driving support system, or the like, the display/alarm/control unit 600 performs display indicating that the system is not operating to the driver. In addition, it may be possible to contract stepwise the automatic driving or the driving support system, for example, it may be possible to stop the vehicle on the road shoulder using only the camera in which no abnormality occurs, or stop the vehicle on the road shoulder using only the normal region of the imaging region.

Furthermore, the display/alarm/control unit 600 may display a request to the driver to confirm the state of the camera in which the abnormality has occurred. In addition, the display/alarm/control unit 600 may output a command to the camera in which the abnormality has occurred to execute an operation of eliminating the abnormality such as activation of a wiper, or injection of the window washer fluid or the compressed air.

As described above, the abnormality diagnosis device 1 of the first embodiment includes the sensor unit 100 in which a plurality of cameras (observing the surrounding environment) are arranged so as to overlap in a visual field; a target detection unit 200 which detects a target based on sensor information (image information) of the sensor unit 100; a target reliability determination unit 400 which determines reliability of the target based on a detection result in a common imaging region in which the plurality of cameras share a visual field; and an individual abnormal image region determination unit 500 which determines an abnormal image region in a monocular region using a tracking result of the target in the monocular region formed only by a visual field of a single camera in the plurality of cameras, wherein the individual abnormal image region determination unit 500 changes an abnormality score of an abnormality score map assigned to the abnormal image region according to the reliability of the target.

Further, the abnormality diagnosis device 1 further includes a common normal region calculation unit 300 which determines a state (normal or abnormal) of the common imaging region based on a detection result in the common imaging region, and the target reliability determination unit 400 determines the reliability of the target based on the state (normal or abnormal) of the common imaging region.

According to the present embodiment, by assigning the reliability to the target according to the detection result of the common imaging region and changing the update amount of the abnormality score map of the monocular region according to the reliability of the target, the abnormal region generated in the sensor (camera) can be determined in a short time without erroneous determination.

### Second Embodiment

The second embodiment is an embodiment in which a plurality of sensors installed in a moving body and observing a surrounding environment is not limited to cameras, and normality or abnormality determination of a common sensing region of a plurality of sensors (including a millimeter wave radar a LiDAR, and the like other than a camera) is performed based on a type and a positional relationship of a target.

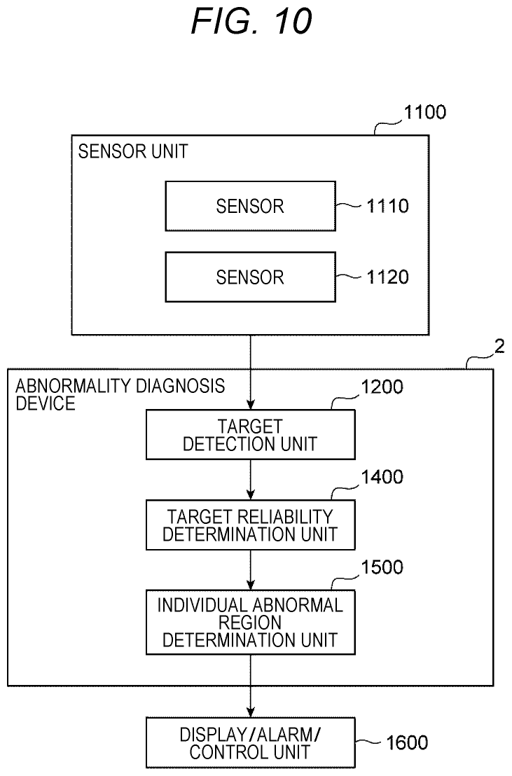

FIG. 10 illustrates an overall configuration diagram of an abnormality diagnosis device according to the second embodiment of the present invention.

An abnormality diagnosis device 2 of the present embodiment is, for example, used as being mounted on a vehicle, and includes a sensor unit 1100, a target detection unit 1200, a target reliability determination unit 1400, an individual abnormal region determination unit 1500, and a display/alarm/control unit 1600.

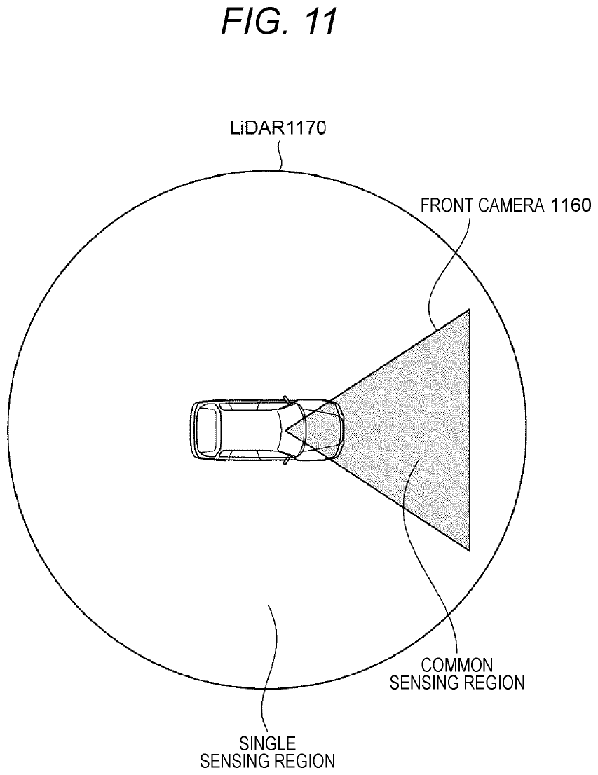

The sensor unit 1100 includes a plurality of sensors. The plurality of sensors are arranged so as to overlap in observation regions (also referred to as sensing regions). FIG. 10 shows an example where two sensors of a sensor 1110 and a sensor 1120 are included in the sensor unit 1100. As illustrated in FIG. 11, the two sensors may be a front camera 1160 and a LiDAR 1170, for example. However, another configuration may be applied if there is a common sensing region that can be sensed by the two sensors (the two sensors share the observation region) and a single sensing region that can be sensed only by one (single) sensor (configured only by the observation region of one (single) sensor), and different types of sensors such as a sonar or a millimeter wave radar may be combined.

The sensor unit 1100 outputs sensing information (detection information) obtained by sensing the surrounding environment to the target detection unit 1200 as sensor information.

The target detection unit 1200 detects a target to be used for estimation of an abnormal region from detection information as sensor information acquired by the sensor unit 1100. The target may be another vehicle, a two-wheeled vehicle, a pedestrian, a sign, an object such as a signboard, or the like.

As a detection method, an arbitrary algorithm suitable for each sensor is selected and used.

The target reliability determination unit 1400 receives the result of the target detection unit 1200 and assigns reliability to each target detected by the target detection unit 1200. The target reliability determination unit 1400 outputs the result of assigning the reliability for each target to the individual abnormal region determination unit 1500.

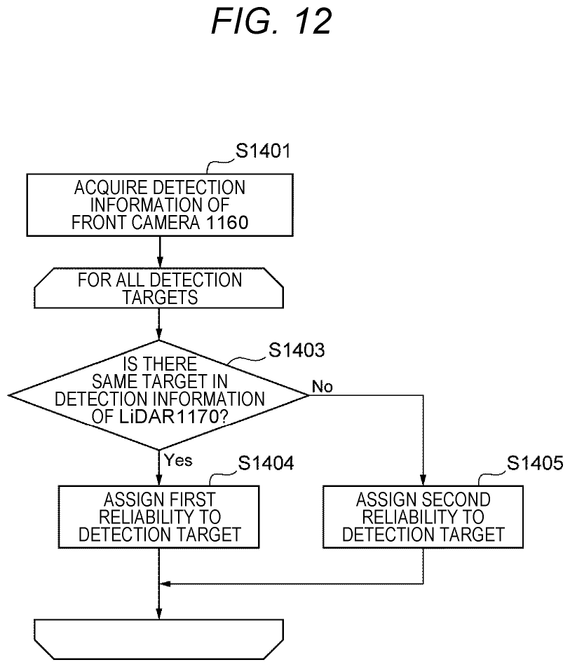

FIG. 12 illustrates a processing flow of the target reliability determination unit 1400. FIG. 12 illustrates an example of the front camera 1160 and the LiDAR 1170, but the present invention is not limited thereto, and a sensor having sensing region information can execute similar common processing.

First, in step S1401, target information (detection information) of the front camera 1160 detected by target detection unit 1200 is acquired.

In step S1403, matching is performed on all the acquired detection targets as to whether the same target exists in the targets (detection information) detected by the LiDAR 1170. Whether the targets are the same is determined based on information such as a position, a type, and a movement direction of target information (detection information).

In a case where the same target exists among the targets detected by the LiDAR 1170 in step S1403, the first reliability is assigned to the detection target in step S1404. In a case where the same target does not exist among the targets detected by the LiDAR 1170 in step S1403, the second reliability is assigned to the detection target in step S1405. That is, the target reliability determination unit 1400 assigns the first reliability to a target that can be observed (as the same target) by two sensors sharing the observation region (step S1404), and assigns the second reliability to a target that can be observed only by a single sensor among two sensors sharing the observation region (step S1405).

The individual abnormal region determination unit 1500 determines an abnormal region in the single sensing region based on the reliability for each target calculated by the target reliability determination unit 1400, and outputs the result to the display/alarm/control unit 1600. Similarly to FIG. 9, the processing flow of the individual abnormal region determination unit 1500 decreases the abnormality score of the abnormality score map in a case where the target can be detected at the prediction position, and increases the abnormality score of the abnormality score map in a case where the target cannot be detected at the prediction position, according to the reliability of the tracking target. That is, in a case where the target is detected (tracked) in the single sensing region, the individual abnormal region determination unit 1500 decreases (lowers) the abnormality score of the abnormality score map of the detection portion (by the first update amount or the second update amount). In addition, in a case where the target is lost (cannot be tracked) in the single sensing region, the individual abnormal region determination unit 1500 increases (heightens) the abnormality score of the abnormality score map of the lost portion (by the first update amount or the second update amount).

After updating the abnormality score of the abnormality score map using all the target information, a predetermined threshold is set for the abnormality score of the updated abnormality score map, and a region in which the score falls below the predetermined threshold is determined as a normal region, and a region in which the score exceeds the predetermined threshold is determined as an abnormal region.

In addition, the abnormality score map may be also updated for a region determined as a normal region or an abnormal region, and it may be determined that an abnormality has occurred in the normal region in a case where the score exceeds the predetermined threshold (dirt adheres during traveling, or the like), or it may be determined that the abnormal region has been restored (dirt removed during traveling, dirt removed by cleaning operation, or the like) in a case where the score falls below the predetermined threshold.

The display/alarm/control unit 1600 acquires information of the normal region or the abnormal region calculated by the individual abnormal region determination unit 1500, and performs display or provides an alarm to the driver, and/or performs control for eliminating an abnormal state.

As described above, the abnormality diagnosis device 2 of the second embodiment includes a sensor unit 1100 in which a plurality of sensors (observing a surrounding environment) are arranged so as to overlap in an observation region; a target detection unit 1200 which detects a target based on sensor information (detection information) of the sensor unit 1100; a target reliability determination unit 1400 which determines reliability of the target based on a detection result in a common sensing region in which the plurality of sensors share an observation region; and an individual abnormal region determination unit 1500 which determines an abnormal region in a single sensing region using a tracking result of the target in the single sensing region formed only by an observation region of a single sensor in the plurality of sensors, wherein the individual abnormal region determination unit 1500 changes an abnormality score of an abnormality score map assigned to the abnormal region according to the reliability of the target.

According to the present embodiment, the reliability is assigned to the target according to the detection result of the common sensing region, and the update amount of the abnormality score map of the single sensing region is changed according to the reliability of the target, so that the abnormal region generated in the sensor (camera, LiDAR, millimeter wave radar, or the like) can be determined in a short time without erroneous determination.

Note that the present invention is not limited to the above-described embodiments, and includes various modifications. For example, the above-described embodiments have been described in detail in order to simply describe the present invention, and are not necessarily limited to those having all the described configurations.

In addition, a part or all of the above-described configurations, functions, processors, processing means, and the like may be realized by hardware, for example, by designing with an integrated circuit. In addition, each of the above-described configurations, functions, and the like may be realized by software by a processor interpreting and executing a program for realizing each function. Information such as a program, a table, a file, and the like for realizing each function can be stored in a storage device such as a memory, a hard disk, and a solid state drive (SSD), or a recording medium such as an IC card, an SD card, a DVD, and the like.

In addition, the control lines and the information lines indicate those necessary for the description, and do not necessarily indicate all the control lines and the information lines on the product. In practice, it may be considered that almost all the configurations are connected to each other.

### Reference Signs List

1 abnormality diagnosis device (first embodiment)
100 sensor unit
200 target detection unit
300 common normal region calculation unit
400 target reliability determination unit
500 individual abnormal image region determination unit
600 display/alarm/control unit
2 abnormality diagnosis device (second embodiment)
1100 sensor unit
1200 target detection unit
1400 target reliability determination unit
1500 individual abnormal region determination unit
1600 display/alarm/control unit

1. An abnormality diagnosis device comprising:
a sensor unit in which a plurality of cameras are arranged so as to overlap in a visual field;
a target detection unit which detects a target based on sensor information of the sensor unit;
a target reliability determination unit which determines reliability of the target based on a detection result in a common imaging region in which the plurality of cameras share a visual field; and
an individual abnormal image region determination unit which determines an abnormal image region in a monocular region using a tracking result of the target in the monocular region formed only by a visual field of a single camera in the plurality of cameras,
wherein the individual abnormal image region determination unit changes an abnormality score of an abnormality score map assigned to the abnormal image region according to the reliability of the target.

2. The abnormality diagnosis device according to claim 1, further comprising a common normal region calculation unit which determines a state of the common imaging region based on a detection result in the common imaging region,
wherein the target reliability determination unit determines reliability of the target based on a state of the common imaging region.

3. The abnormality diagnosis device according to claim 2, wherein the common normal region calculation unit calculates, as a common normal region, an identical pixel matched between cameras sharing a visual field.

4. The abnormality diagnosis device according to claim 3, wherein the target reliability determination unit assigns a first reliability to a target detected in the common normal region, and assigns a second reliability different from the first reliability to a target detected outside the common normal region.

5. The abnormality diagnosis device according to claim 4, wherein the target reliability determination unit sets the first reliability to a value higher than the second reliability.

6. The abnormality diagnosis device according to claim 1, wherein the individual abnormal image region determination unit lowers an abnormality score of an abnormality score map of a detection portion in a case where the target is detected in the monocular region.

7. The abnormality diagnosis device according to claim 1, wherein the individual abnormal image region determination unit heightens an abnormality score of an abnormality score map of a lost portion in a case where the target is lost in the monocular region.

8. The abnormality diagnosis device according to claim 1, wherein the individual abnormal image region determination unit determines a region in which a value of the abnormality score map exceeds a predetermined threshold as an abnormal region, or determines a region in which a value of the abnormality score map falls below a predetermined threshold as a normal region.

9. The abnormality diagnosis device according to claim 1, wherein the individual abnormal image region determination unit updates an abnormality score of an abnormality score map to be larger as the reliability of the target is higher.

10. An abnormality diagnosis device comprising:
a sensor unit in which a plurality of sensors are arranged so as to overlap in an observation region;
a target detection unit which detects a target based on sensor information of the sensor unit;
a target reliability determination unit which determines reliability of the target based on a detection result in a common sensing region in which the plurality of sensors share an observation region; and
an individual abnormal region determination unit which determines an abnormal region in a single sensing region using a tracking result of the target in the single sensing region formed only by an observation region of a single sensor in the plurality of sensors,
wherein the individual abnormal region determination unit changes an abnormality score of an abnormality score map assigned to the abnormal region according to the reliability of the target.

11. The abnormality diagnosis device according to claim 10, wherein the target reliability determination unit assigns a first reliability to a target observed by a plurality of sensors sharing an observation region, and assigns a second reliability different from the first reliability to a target observed only by a single sensor in the plurality of sensors sharing an observation region.

12. The abnormality diagnosis device according to claim 11, wherein the target reliability determination unit sets the first reliability to a value higher than the second reliability.

13. The abnormality diagnosis device according to claim 10, wherein the individual abnormal region determination unit lowers an abnormality score of an abnormality score map of a detection portion in a case where the target is detected in the single sensing region.

14. The abnormality diagnosis device according to claim 10, wherein the individual abnormal region determination unit heightens an abnormality score of an abnormality score map of a lost portion in a case where the target is lost in the single sensing region.

15. The abnormality diagnosis device according to claim 10, wherein the individual abnormal region determination unit determines a region in which a value of the abnormality score map exceeds a predetermined threshold as an abnormal region, or determines a region in which a value of the abnormality score map falls below a predetermined threshold as a normal region.
